(19) United States
(12) Patent Application Publication
(10) Pub. No.: US 2007/0240304 A1
(43) Pub. Date: Oct. 18, 2007

(54) RFID article with interleaf

(76) Inventors: Randolph W. Eisenhardt, Fargo, ND (US); Eric Lee, San Jose, CA (US); Joshua DeCock, Fargo, ND (US)

Correspondence Address: James C. Scheller, Jr.;BLAKELY, SOKOLOFF, TAYLOR & ZAFMAN LLP, Seventh Floor, 12400 Wilshire Boulevard, Los Angeles, CA, 90025-1026, US

(21) Appl. No.: 11/732,577

(22) Filed: Apr. 3, 2007

Related U.S. Application Data
(60) Provisional application No. 60/791,766, filed on Apr. 12, 2006.

(51) Int. Cl. H01R 43/00; G08B 13/14

(52) U.S. Cl. 29/825; 340/572.8

(57) ABSTRACT

Techniques for an RFID article in roll format are provided. The RFID article includes a plurality of inlays on a flexible substrate. The inlays including integrated circuits coupled to antennas. The RFID article further includes at least one interleaf that is disposed to one side of integrated circuits of the inlays. In specific embodiments, the RFID article includes two interleafs disposed on opposite sides of the integrated circuits.

The application is related to and claims the benefit of the filing date of U.S. Provisional Patent Application No. 60/791,766, filed on Apr. 12, 2006, and entitled “RFID Article with Interleaf”, which provisional application is incorporated herein by reference.

### FIELD OF THE TECHNOLOGY

The present invention generally relates to radio frequency identification (RFID), and more particularly to RFID articles in a roll format. But, it will be recognized that the invention has a wider range of applicability. Merely by way of example, the invention may be applied to the manufacture of electronic devices by a roll-to-roll process.

### BACKGROUND

Radio frequency identification (RFID) is a technology that incorporates the use of electromagnetic or electrostatic coupling in the radio frequency (RF) portion of the spectrum to uniquely identify an item (e.g., object, animal, or person). An RFID system includes a tag, or transponder, placed on an item to be tracked. There are three basic types of RFID tags: passive (beam powered, backscatter transmission), semi-passive (battery powered, backscatter transmission), and active (battery or externally powered, active transmission). Although each type of tag operates in fundamentally different ways, all enjoy the advantage that they do not require line-of-sight scanning necessary for bar codes.

Widespread adoption of RFID technology as an alternative to bar codes requires inexpensive tags. High volume manufacturing methods are currently employed to reduce the cost of tags. These manufacturing methods use densely packed webs for roll-to-roll processes (commonly referred to as “R2R”). Roll-to-roll processes allow continuous processing of a web, or a long flexible substrate. The web can be continuously directed by rollers though manufacturing steps, which is typically more efficient than using sheets in a batch process.

Roll-to-roll processes often begin and finish with products in a roll format. For example, FIG. 1 illustrates a conventional roll 100 of inlays (also referred to as inlets) manufactured by Alien Technology Corporation. Each inlay on the roll includes at least an antenna 102 and a surface mounted RFID integrated circuit 104. This conventional roll of inlays can be later converted into finished tags or RFID labels by further processing, including by further roll-to-roll processing.

However, the economic efficiencies of roll-to-roll processing are not always enjoyed. For example, during handling of roll 100, RFID integrated circuits 104 are subject to mechanical stresses that often cause damage (e.g., die chipping and breakage). Device yields on conventional roll 100 can be significantly reduced, thereby increasing manufacturing costs.

From the above, it is seen that improved techniques for RFID articles in roll format are desired.

### SUMMARY OF THE DESCRIPTION

The inventors realize that in a roll format the mechanical stress experienced by an integrated circuit (IC) of an RFID device is due, at least in part, to IC stack up. That is to say, in a roll format, the IC chips cause a ridge to build up as successive layers of inlays are wound on top of each other. The ridge bears the tension of the roll and serves as a stress concentrator, thereby increasing the IC chips' susceptibility to cracking.

Accordingly, improved techniques for an RFID article in roll format are provided. The RFID article includes a plurality of inlays on a flexible substrate. The inlays include integrated circuits coupled to antennas. The RFID article further includes at least one interleaf that is disposed to one side of integrated circuits of the inlays. The at least one interleaf alleviates, at least in part, mechanical stress on the integrated circuits by reducing the ridge.

In another embodiment of the present invention, an RFID article in a roll format includes a plurality of inlays spaced on a flexible substrate. The RFID article further includes first and second interleafs disposed on opposite sides of integrated circuits of the inlays. The first and second interleafs provide a protective support that reduces the mechanical stresses on the integrated circuits. A gap is disposed between the first and second interleafs to expose the integrated circuits.

In yet another embodiment of the present invention, an RFID article in roll format includes a plurality of inlays spaced on a flexible substrate. The inlays include integrated circuits coupled to antennas. An interleaf is disposed above the integrated circuits in order to reduce stresses on the integrated circuits. The interleaf includes cutouts to expose the integrated circuits or protective regions, aligned with the integrated circuits, to protect (e.g. cushion) the integrated circuits.

In another embodiment of the present invention, a method of forming an RFID article includes unwinding first and second interleafs, and providing an inlay web. The first and second interleafs are disposed on opposite sides of integrated circuits of the inlays. The first interleaf, second interleaf, and the inlay web are rolled together.

Many advantages are achieved by way of the present invention, such as: (i) implementation using conventional roll-to-roll equipment, (ii) improved inlay yields, and (iii) reusability of interleafs for greater economy. Depending upon the embodiment, one or more of these advantages, as well as others, may be achieved.

Various additional objects, features, and advantages of the present invention can be more fully appreciated with reference to the detailed description and accompanying drawings that follow.

### BRIEF DESCRIPTION OF THE DRAWINGS

The present invention is illustrated by way of example and not limitation in the figures of the accompanying drawings in which like references indicate similar elements.

FIG. 1 illustrates a conventional roll of inlays.

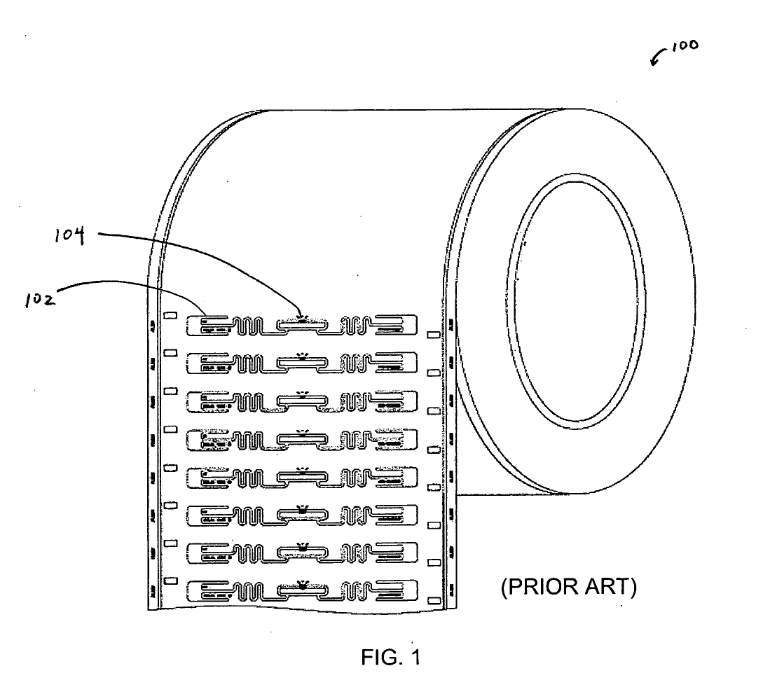

FIG. 2 illustrates a roll of inlays according to an embodiment of the present invention.

FIGS. 3(a)-(c) illustrate an interleaf with inlay web according to an embodiment of the present invention.

FIGS. 4(a)-(e) show interleafs according to alternative embodiments of the present invention.

FIG. 5 illustrates simplified block diagram for manufacturing an RFID article with interleafs according to an embodiment of the present invention.

FIG. 6 illustrates simplified block diagram for manufacturing an RFID label according to an embodiment of the present invention.

FIG. 7 shows experimental test data using an embodiment of the present invention.

FIG. 8 shows experimental test data using an embodiment of the present invention.

FIG. 9 illustrates a roll core according to an embodiment of the present invention.

### DETAILED DESCRIPTION

The following description and drawings are illustrative of the invention and are not to be construed as limiting the invention. Numerous specific details are described to provide a thorough understanding of the present invention. However, in certain instances, well known or conventional details are not described in order to avoid obscuring the description of the present invention. References to one or an embodiment in the present disclosure are not necessarily references to the same embodiment; and, such references mean at least one.

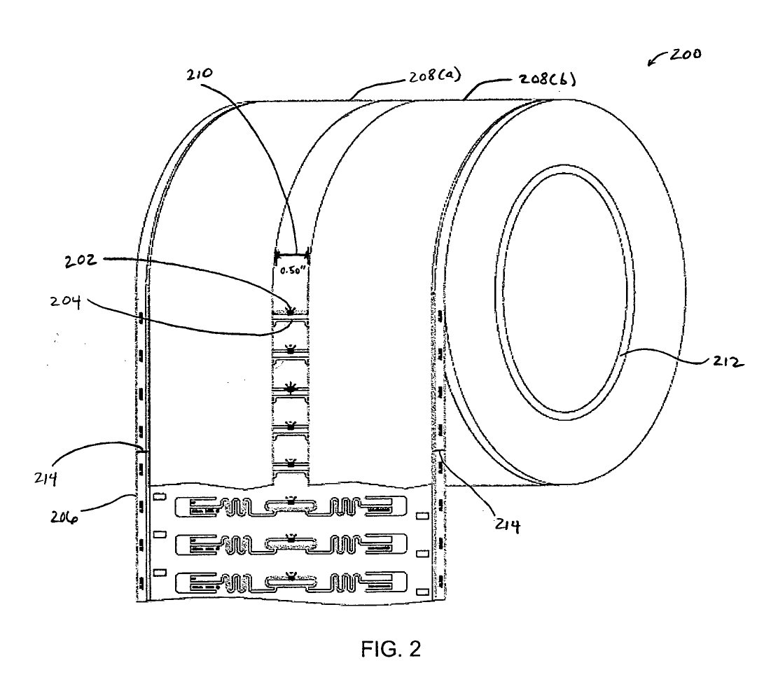

FIG. 2 illustrates a roll 200 of inlays according to an embodiment of the present invention. Each inlay of roll 200 includes an RFID IC chip 202 electrically coupled, either capacitively, inductively, or resistively, to an antenna 204 on substrate 206. In this example, roll 200 is wound with inlays facing outwards; however, in other embodiments a roll can be wound with inlays facing inwards to the roll core. In addition, in other embodiments, each inlay on a roll can include multiple IC chips, such as for sensors.

Roll 200 further includes interleafs 208(a)-(b). Interleafs 208(a)-(b) are disposed on opposites sides of the IC chips (for example, IC chip 202). A gap 210 exists between interleafs 208(a)-(b) exposing the IC chips. Gap 210 is depicted in FIG. 2 to be about 0.50 inches (or about 1.27 centimeters), but gap 210 can range from about 0.25 inches to about 1.0 inches. The existence of gap 210 reduces, or eliminates, a ridge on roll 200 due to IC stack up.

Interleafs 208(a)-(b) can be made from any flexible material, such as plastic, fabric, paper stock, or other suitable materials. The interleaf material and/or any coating thereon can also be electrostatic discharge (ESD) dissipative. In one embodiment, paper parchment having a caliper, or thickness, ranging from about 0.002 inches to about 0.008 inches is used. It should be understood that the thickness of interleafs 208(a)-(b) can be less than, or even much less than, the height of IC chip 202 above substrate 206 (whether IC chip 202 is surface mounted or partially embedded in substrate 206). In another embodiment, the thickness of interleafs 208(a)-(b) ranges from about 23.5% to about 95% of the height of IC chip 202. Alternatively, interleaf thickness can be related to the pitch of IC chips 202. That is, on average for an entire roll, an aggregate thickness of interleafs intervening between IC chips 202 stacked at the same radial position on the roll can be about, or greater than, the height of IC chip 202 above the substrate 206.

In yet another embodiment, interleafs 208(a)-(b) can have differing thickness (e.g., interleaf 208(a) can be thicker than interleaf 208(b)). It should also be noted that an interleaf need not have a uniform thickness throughout its length. For example, an interleaf can be thicker closer to the roll core relative to its thickness at an outer periphery of the roll. Further, an RFID article can have discontinuous interleafs or, in other words, a plurality of interleafs can used along a down web length of the inlay web.

Interleafs can extend in a cross web direction to have coincident edges with the underlying substrate 206. However, in the embodiment shown in FIG. 2, interleafs 208(a)-(b) leave lengths 214 between edges of substrate 206 and interleafs. Lengths 214 can expose sprocket holes, reel holes, or alignment marks, if any, that may be useful for web handling.

For typical applications of the present invention in low cost RFID systems, IC chip 202 is a beam power (e.g., passive) device because of its inexpensive cost, although battery powered and active devices can also be used. A NanoBlock™ IC made by Alien Technology Corporation is an example of an IC chip used for a passive tag. IC chip 202 can be surface mounted using, for example, pick and place methods, or embedded (or partially embedded) into substrate 206 using fluidic self assembly (FSA) processes (as described in, for example, U.S. Pat. No. 6,927,085, which is incorporated by reference herein for all purposes) or vibration processes.

Alternatively, IC chip 202 can be embedded in, or surface mounted on, a strap assembly, and the strap assembly then coupled to substrate 206. Additional details relating to strap assemblies and the manufacture thereof can be found in U.S. Pat. No. 6,606,247 and U.S. Patent Publication No. 2004/0183182, which are hereby incorporated herein by reference for all purposes. In one embodiment, gap 210 can expose, entirely or partially, the strap assemblies of the web. In another specific embodiment, a gap between interleafs can be sufficiently large to expose markings on the strap assemblies, particularly markings indicating good or defective strap assemblies.

Antenna 204 can be printed, sputtered, deposited, transfer laminated, or etched onto substrate 206. In one embodiment, gravure printing can be used for its high speed and low cost. Antenna 204 is preferably metal (e.g., silver, copper, and the like), but can be any suitably conductive material. Antenna 204 can be a monopole antenna, dipole antenna, folded dipole antenna, loop antenna, circularly polarized (CP) antenna, double dipole antenna, or the like.

Substrate 206 can be rigid or preferably flexible, and monolayer or multilayer. It can be made from polymeric, plastic, fabric, metal, or other suitable materials. Example of suitable materials that can be used for the substrate 206 include, but are not limited to, polyethylene, paper, polystyrene, polypropylene, polynorbornene, polycarbonate, polysulfone, polyethersulfone, polyetherimide, polyamide, polyetherimide, polyester polyarylate, polyethyleneterephthalate, and polyethylenenaphthalate, and derivatives thereof.

Substrate 206 is wound about a roll core 212 in successive layers. The roll core 212 is made from a load bearing material, such as plastic or cardboard, to support the weight of substrate 206. Alternatively, roll core 212 can be a “soft core” made from foam over the cardboard or plastic, and thus the substrate 206 is not in direct contact with the hard core of plastic or cardboard. In particular embodiments, roll core 212 has an inner diameter of at least about 3 inches.

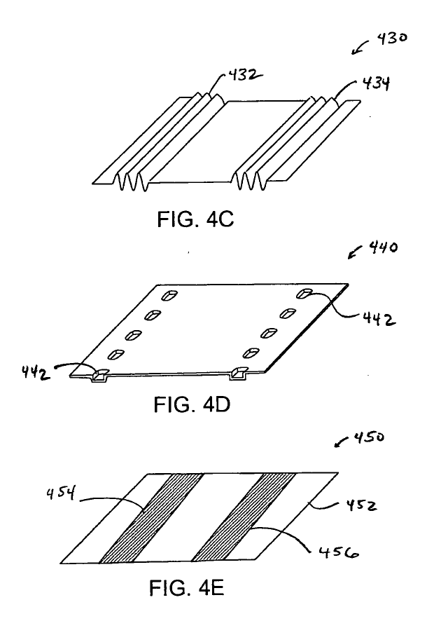

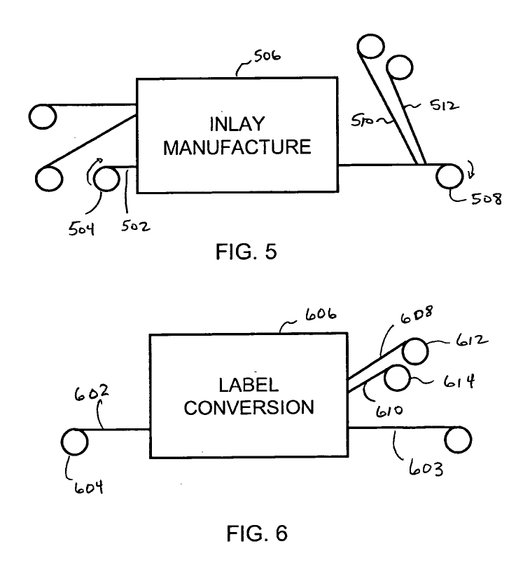

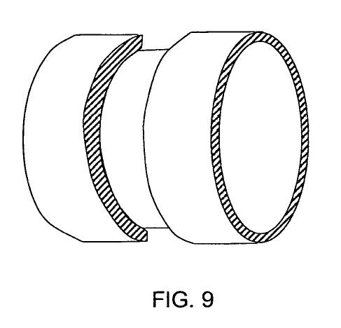

In order to further reduce mechanical stresses on ICs, a roll core can include a recessed band around its circumference, such as about the center of its circumference as illustrated in FIG. 9. Typically, the band is aligned with the position of the ring of ICs on a roll. Based on the teachings herein, it should be understood that rollers used in a manufacturing process, such as those processes described in connection with FIGS. 5 and 6 below, can also include a recessed band to reduce the possibility of IC damage during manufacturing.

Text, bar codes, and/or identifiers can be printed on interleafs, as interleafs can be made from paper stock. For example, company logos, patent markings, notices, part numbers, bar codes and/or identifiers and the like can be printed on interleafs. In lieu of printed matter, an RFID tag can be coupled to an interleaf for storing information and tracking.

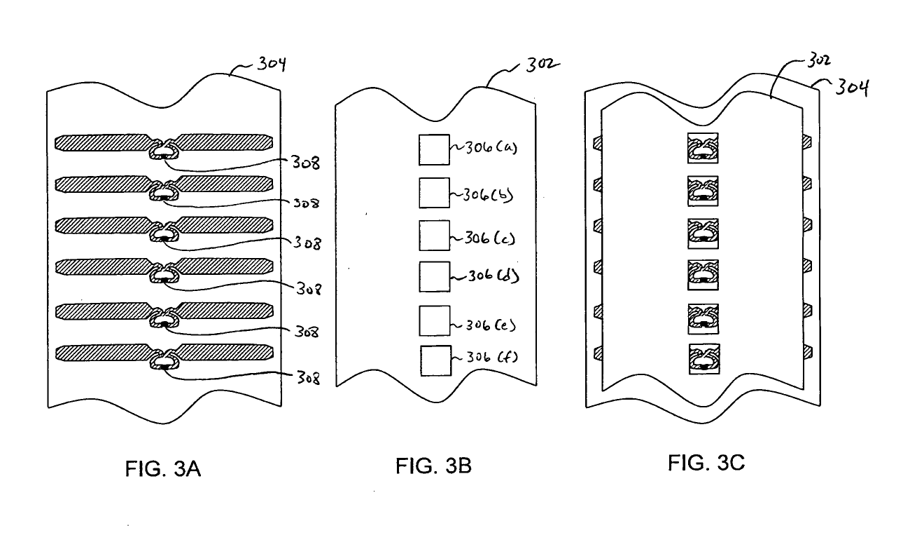

FIGS. 3(a)-(c) illustrate an interleaf 302 with inlay web 304 according to an embodiment of the present invention. Interleaf 302 includes cutouts 306(a)-(f) spaced to correspond to IC chips 308 on inlay web 304. In this particular example, cutouts 306(a)-(f) are square, but in other embodiments they can take any arbitrary shape (e.g., shaped as a triangle, circle, ellipse, rectangle, polygon, star, or the like). An important feature of interleaf 302 is that the cutouts are disposed over the IC chips 308 to expose the IC chips, as depicted in FIG. 3(c). In embodiments having strap assemblies, the cutouts can expose, entirely or partially, the strap assemblies. In certain alternative embodiments, an interleaf may have, rather than the cutouts, protective regions which may be aligned with the integrated circuits (ICs) to protect (e.g. cushion) the ICs. These protective regions may be softer than the surrounding areas of the interleaf. The protective regions may be regions of the interleaf which are treated to make them softer (e.g. spongy) or thinner relative to the rest of the interleaf. The treatment may be a chemical treatment or an exposure to electromagnetic energy which softens selected areas (the protective regions) of the interleaf. The protective regions may be implemented as a long (down web) contiguous strip rather than discontinuous regions.

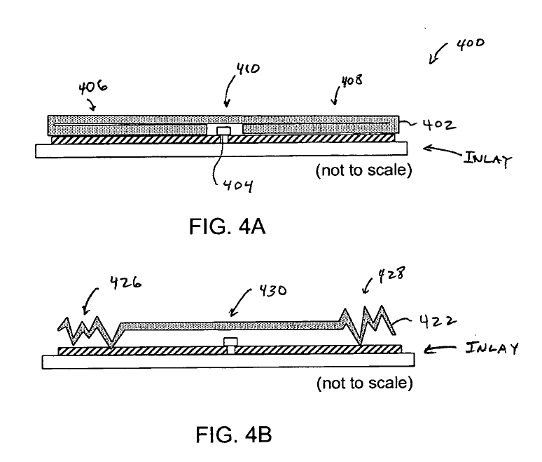

FIG. 4(a) illustrates an RFID article 400 according to an alternative embodiment of the present invention. RFID article 400 includes interleaf 402 that overlies the inlay, including IC chip 404. In this example, interleaf 402 has two layers, but in other embodiments it may have any arbitrary number of layers (e.g., 3, 4, 5, or more layers). It is important that the thickness of the interleaf 402, achieved by the layering, is greater in the peripheral regions 406 and 408 than in the central region 410 proximate to IC chip 404. The increased thickness in the peripheral regions 406 and 408 reduces, or eliminates, ridges typically found in RFID articles in a roll format.

FIG. 4(b) illustrates an interleaf 422 according to an alternative embodiment of the present invention. As opposed to interleaf 402 in FIG. 4(a), interleaf 422 has a single layer structure. Non-uniformities in peripheral regions 426 and 428 effectively increase the thickness of interleaf 422 relative to central region 430. Non-uniformities may include folds, creases, pleats, wrinkles, or the like in interleaf 422. An interleaf can take the shape of a lasagna layer (e.g., flat middle portion and sinusoidal edges in the periphery). Interleafs can also be textured, such as by being made from textured paper having sufficient structure to prevent, or reduce, the wound web from focusing stress on an area proximate to the ICs of the web.

FIGS. 4(c)-(e) illustrate alternative interleafs for use with RFID articles with single interleaf. Interleaf 430 of FIG. 4(c) includes two embossed areas 432 and 434. These embossed areas 432 and 434 increase the interleaf height in areas disposed sufficiently away from ICs of on the web. In FIG. 4(d), embossed areas 442 are disposed on a periphery of interleaf 440. The embossed areas 442 provide additional height in the periphery. In lieu of embossed areas, second layer interleafs 454 and 456 can be coupled to a first interleaf layer 452. This multilayer interleaf 450 is illustrated in FIG. 4(e).

FIG. 5 illustrates simplified block diagram for manufacturing an RFID article with interleafs according to an embodiment of the present invention. A web 502 is unwound at reel 504. Web 502 can include evenly spaced antennas thereon or, alternatively, antennas can be printed during inlay manufacture 506. Web 502 is processed by inlay manufacture 506, whereby IC chips (or straps containing IC chips) are coupled to antennas on web 502. Inlay manufacture 506 is not described in order to avoid obscuring the description of the present invention. That said, simple examples of inlay manufacture 506 are described in U.S. Pat. No. 6,779,733, entitled “Noncontact ID Card or the like and Method of Manufacturing the Same,” and U.S. Pat. No. 6,951,596, entitled “RFID Label Technique,” which are both incorporated by reference herein for all purposes.

After inlay manufacture 506, reel 508 takes up web 502 along with interleafs 510 and 512. Interleafs 510 and 512, in this example, are disposed on opposites sides (e.g., left side and right side) of the IC chips. Interleafs 510 and 512 remain in place by the tension on the roll. In an alternatively embodiment, interleafs 510 and 512 can be removably attached to web 502 using an adhesive. In fact, interleafs 510 and 512 can include an adhesive backing.

FIG. 6 illustrates simplified block diagram for manufacturing an RFID label according to an embodiment of the present invention. An inlay web 602 with dual interleafs is unwound at reel 604. Web 602 is processed by label conversion 606, whereby a release liner, adhesive layer, and/or a facestock web are coupled to web 602 to produce a label web 603. These details of label conversion 606 are not described in order to avoid obscuring the description of the present invention, but examples of label conversion 606 are described in U.S. Pat. Nos. 6,779,733 and 6,951,596. For embodiments of the present invention, interleafs 608 and 610 are separated from web 602 and taken up by reels 612 and 614, respectively. Interleafs 608 and 610 can then be reused for further economy.

In alternative embodiments, manufacturing of an RFID article can include coupling a first interleaf on a first surface of a web substrate and coupling a second interleaf on a second surface of the web substrate. For example, a first interleaf can be coupled to an inlay web on a top surface and a second interleaf can be coupled to the inlay web on a bottom surface. Thus, interleafs can be processed on differing planes.

### EXAMPLES

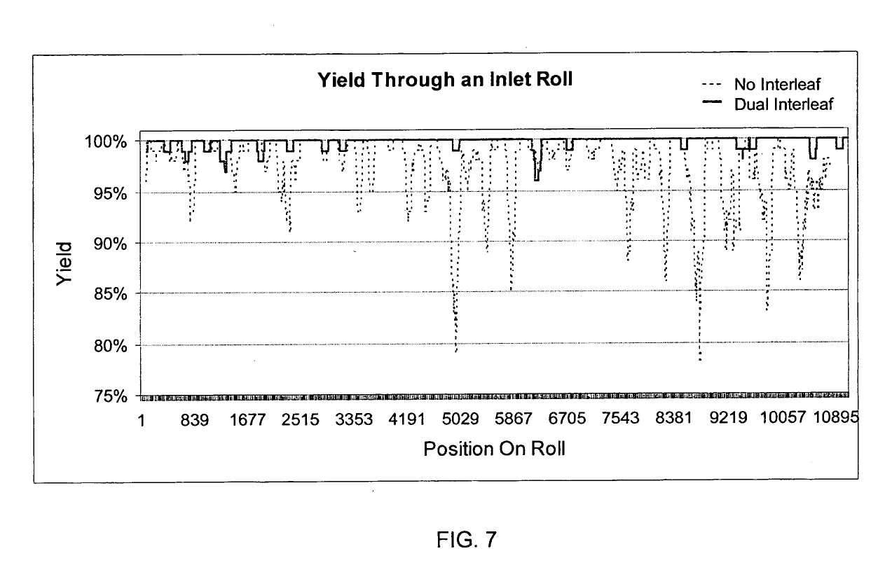

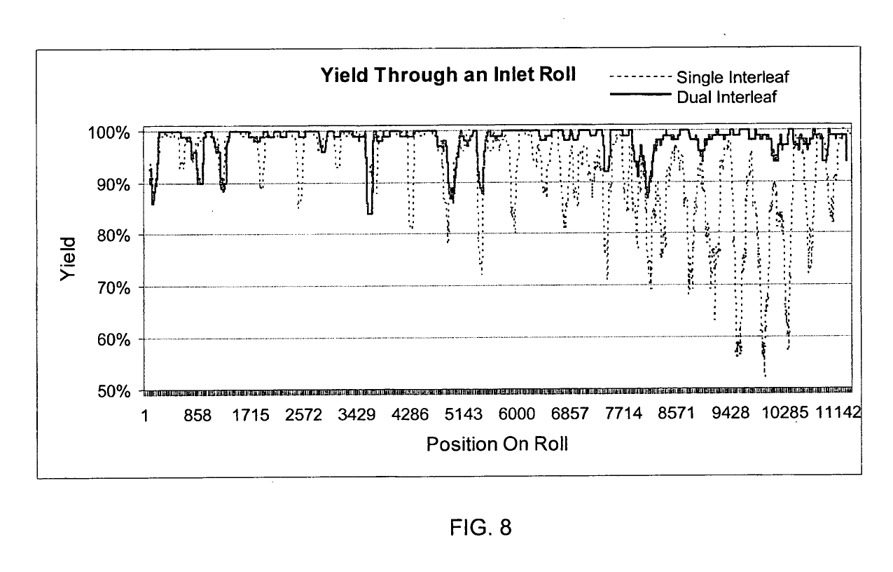

To prove the principle and operation of the present invention, the inventors performed experiments. These experiments are merely examples and should not unduly limit the scope of the inventions defined by the claims herein. One of ordinary skill in the art would recognize many other variations, modifications, and alternatives. From these experiments, it was demonstrated that interleafs are ideal for articles in roll format. Interleafs substantially increase device yields as clearly illustrated in FIGS. 7 and 8.

Using dual interleafs on rolls, the resulting yields for inlays as positioned on a roll generally increased, in some cases substantially. For example, in FIG. 7, inlays at about inlay position 5029 on conventional rolls without interleafs were tested to have a yield of less 90%, or even less than 80%, while rolls incorporating dual interleafs had a yield of about 99% at corresponding positions. Also, yields generally decreased towards the core of the roll for conventional rolls. However, the dual interleaf rolls had substantially uniform yields for their entire length.

FIG. 8 compares test results for dual interleaf rolls to single interleaf rolls. The dual interleaf rolls generally performed significantly better. For example, in specific test runs, inlays at about position 9428 on rolls with a single interleaf were tested to have a yield of less 60%, while rolls incorporating dual interleafs had a tested yield of about 99%. As confirmed by the experimental results in FIGS. 7 and 8, inlay rolls with dual interleafs have increased yields over both single interleaf rolls and conventional rolls without interleafs.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. An RFID article comprising:
a plurality of inlays spaced on a flexible substrate in a roll format, the inlays including integrated circuits coupled to antennas;
first and second interleafs disposed on opposite sides of the integrated circuits, the first and second interleafs configured to reduce a mechanical stress on the integrated circuits when the RFID article is in a roll format; and
a gap disposed between the first and second interleafs exposing the integrated circuits.

2. The RFID article of claim 1 wherein the first interleaf comprises at least one of plastic, fabric, and paper parchment.

3. The RFID article of claim 1 wherein the gap is at least about 0.25 inches.

4. The RFID article of claim 1 wherein the first interleaf has a thickness less than 0.008 inches.

5. The RFID article of claim 1 wherein the first interleaf has a thickness that ranges from about 23% to about 95% of a height of the integrated circuits.

6. The RFID article of claim 1 wherein the first interleaf has a width of at least about 1 inch.

7. The RFID article of claim 1 wherein the RFID article has an unwound length of at least 60 meters.

8. The RFID article of claim 1 wherein the first interleaf has an unwound length substantially equal to the unwound length of the flexible substrate.

9. The RFID article of claim 1 further comprising a roll core, the roll core includes a recessed band about a circumference of the roll core.

10. The RFID article of claim 1 further comprising a roll core comprising a load bearing material, the roll core having an inner diameter of at least about 3 inches, and the load bearing material including at least one of plastic or cardboard.

11. The RFID article of claim 1 wherein the first interleaf includes printed matter, the printed matter including at least one of a bar code, machine readable symbology, and human intelligible text.

12. The RFID article of claim 1 wherein integrated circuits are either resistively or capacitively coupled to the antennas.

13. The RFID article of claim 1 wherein the integrated circuits are surface mounted to strap assemblies.

14. An RFID article in roll format comprising:
a plurality of inlays spaced on a flexible substrate, the inlays including strap assemblies coupled to antennas; and
a first interleaf disposed away from a first side of the strap assemblies in order to protect integrated circuits of the strap assemblies from mechanical stresses.

15. The RFID article of claim 14 further comprising a second interleaf disposed away from a second side of the strap assemblies in order to protect the integrated circuits from mechanical stress.

16. The RFID article of claim 15 wherein the first and second interleafs are disposed on opposite sides of the strap assemblies.

17. The RFID article of claim 14 wherein the first interleaf comprises at least one of plastic, fabric, and paper parchment.

18. The RFID article of claim 14 wherein the first interleaf has a thickness of at least 0.002 inches.

19. An RFID article in roll format comprising:
a plurality of inlays spaced on a flexible substrate, the inlays including integrated circuits coupled to antennas; and
an interleaf disposed over the inlays in order to protect the integrated circuits from mechanical stresses, the interleaf including cutouts to expose the integrated circuits.

20. An RFID article in roll format comprising:
a first roll layer including a first plurality of inlays spaced on a flexible substrate, the first plurality of inlays including integrated circuits coupled to antennas;
a second roll layer including a second plurality of inlays spaced on a flexible substrate, the second plurality of inlays including integrated circuits coupled to antennas; and
at least one removable interleaf disposed between the first roll layer and the second roll layer.

21. A method of forming an RFID article, the method comprising:
unwinding first and second interleafs;
providing an inlay web, the inlay web including integrated circuits coupled to antennas; and
rolling together the first interleaf, second interleaf, and the inlay web in an automatic and continuous process,
wherein the first and second interleafs are disposed on opposite sides of the integrated circuits.

22. An RFID article comprising:
a plurality of RFID tags spaced on a flexible substrate in a roll format, the tags including integrated circuits coupled to antennas;
first and second interleafs disposed on opposite sides of the integrated circuits, the first and second interleafs protecting the integrated circuits from mechanical stresses when the RFID article is in a roll format; and
a gap disposed between the first and second interleafs exposing the integrated circuits,
wherein the first and second interleafs are ESD dissipative.

23. An RFID article comprising:
a plurality of inlays spaced on a flexible substrate in a roll format, the inlays including integrated circuits coupled to antennas, the integrated circuits being surface mounted to the flexible substrate;
first and second interleafs disposed on opposite sides of the integrated circuits, the first and second interleafs protecting the integrated circuits from mechanical stresses when the RFID article is in a roll format, and the first and second interleafs having a height less than a height of the integrated circuit; and
a gap disposed between the first and second interleafs exposing the integrated circuits.

24. The RFID article of claim 23 wherein the integrated circuits are surface mounted to strap assemblies, each strap assembly being singulated from a second flexible substrate and comprising an integrated circuit and a portion of the second flexible substrate.

25. An RFID article comprising at least one interleaf, the RFID article in a roll format.

26. An RFID article as in claim 25 wherein the at least one interleaf includes protective regions aligned with positions of ICs of the RFID article.
